(19) United States
(12) Patent Application Publication
(10) Pub. No.: US 2026/0283141 A1
(43) Pub. Date: Sep. 24, 2026

(54) DEVICE AND METHOD FOR UNDERGROUND RODENT EXTERMINATION WITH ABOVE GROUND CONTROLS

(71) Applicants: Jennifer Garvey, Alpine, CA (US); Richard Ducharme, Alpine, CA (US)

(72) Inventors: Jennifer Garvey, Alpine, CA (US); Richard Ducharme, Alpine, CA (US)

(21) Appl. No.: 19/212,669

(22) Filed: May 20, 2025

Related U.S. Application Data
(60) Provisional application No. 63/649,721, filed on May 20, 2024.

(51) Int. Cl. A01M 23/38; A01M 17/00

(52) U.S. Cl. CPC A01M 23/38; A01M 17/00

(57) ABSTRACT

One or more embodiments of the present disclosure relate to a system and method for rodent extermination. The rodent extermination system can include an outer casing to penetrate a ground surface and access a rodent tunnel. A rodent trap may be removably housed within an internal cavity of the outer casing, and can be deployed within a hole in the ground formed by the outer casing. The rodent trap can house an electric shock assembly. The in-ground rodent trap can have an above ground panel that can include a solar panel. The rodent trap can have an electric shock assembly with electrodes disposed to form an open passage for entry of a rodent, and the electrodes can deliver an electric shock to the rodent. The device can include an above-ground switch to activate the electric shock assembly when the trap is installed in the ground.

### RELATED APPLICATIONS

This application claims the benefit of co-pending U.S. Provisional Application Ser. No. 63/649,721, filed May 20, 2024, the entire disclosure of each of which is herein incorporated by reference.

### FIELD OF THE INVENTION

The present invention generally relates to pest control devices and, in particular, relates to a device and method for rodent extermination.

### BACKGROUND OF THE INVENTION

Rodents, including species such as gophers, moles, voles, ground squirrels, prairie dogs, and rats, have historically posed significant problems in residential, commercial, and agricultural settings. Their underground tunnelling activities often result in extensive damage to crops, landscaping, irrigation systems, and underground wiring. Traditional efforts to control rodent populations have relied heavily on mechanical traps and chemical rodenticides. Mechanical traps, such as spring-loaded wire traps and noose-based traps, typically operate by physically capturing or injuring the rodent upon mechanical activation. Chemical rodenticides, on the other hand, involve the deployment of toxic substances intended to eliminate rodents upon ingestion. Both approaches, while historically utilized, present notable shortcomings.

Mechanical traps often suffer from inconsistent success rates and require frequent manual inspection and resetting. Their effectiveness is highly dependent on environmental factors such as soil density, tunnel depth, and rodent behavior patterns. In many cases, mechanical traps fail to activate properly or allow the rodent to bypass the trap entirely, leading to repeated damage and increased labor for property owners. Furthermore, improperly set mechanical traps can cause prolonged suffering of the animal, raising animal welfare concerns.

Chemical rodenticides pose even more serious risks. In addition to causing potential secondary poisoning of non-target wildlife, including predators such as owls and hawks, rodenticides introduce persistent toxins into the environment. Such chemicals may contaminate soil and groundwater, leading to broader ecological and public health consequences. Regulatory agencies, including the Environmental Protection Agency (EPA), have increasingly restricted or discouraged the use of chemical rodenticides, further complicating pest control efforts.

All of the previously existing means for eliminating underground rodents suffer from structural problems and inconveniences. An effective trap for burrowing and underground rodents needs to be easily placed in line with current underground rodent pathways. However, placing a trap along an underground pathway is exceedingly difficult, and the disruption to the surrounding area may cause the burrowing rodents to simply develop a new pathway instead of walking into the rodent trap. Furthermore, any trap placed underground along the rodent pathway is difficult for a user to monitor and clean out when rodents are caught. Additionally, being underground severely constrains the physical motion and mechanics of rodent traps with moving parts. This requires that any trap underground must be large enough to contain all moving parts within the walls of the trap, and this large size further compounds the problems of having to dig down and place a large trap within the rodent pathway underground.

Accordingly, there exists a need for an improved rodent extermination solution that overcomes the above-mentioned drawbacks. Specifically, there is a need for a device and method for rodent extermination that ensures rapid and humane extermination of rodents, maximizes user convenience, reduces environmental hazards, minimizes the need for constant human intervention, and provides a durable, reusable design suitable for both residential and commercial environments.

### SUMMARY OF THE INVENTION

The system and method described herein can exterminate rodents through an electrically operated shock assembly. The device can include an outer casing configured to penetrate a ground surface and access a rodent tunnel, and an inner casing removably housed within the outer casing. The inner casing can be installed in a hole in the ground created by the outer casing. The inner casing can include a power source comprising at least one battery and at least one solar panel, and a switch mounted on a top plate to activate or deactivate the electric shock assembly. The solar panel, switch, and or an indicator light can be on an above-ground panel that can allow the user to observe the status and control the operation of the trap while the inner casing remains in the hole in the ground. In this way, the trap can be actively set for underground and burrowing rodents, while the control system and solar panels remain above the surface.

In an embodiment, a rodent extermination system can include an outer casing. The outer casing can include a cylindrical outer body adapted to create a cylindrical hole between an underground rodent tunnel and a surface of the ground, and one or more handles disposed around the upper portion of the outer casing, the handles adapted for a user to push and/or twist the cylindrical outer body into the ground. The rodent extermination system can include a rodent trap, and the rodent trap can include an elongated inner casing that can be sized and shaped to fit within a hole created by the cylindrical outer body, the elongated inner casing defining a chamber at a bottom portion of the elongated inner casing, a plurality of electrodes within the chamber, and a power source adapted to provide electric current to the electrodes to electrocute a rodent.

The system can include an above ground panel at an upper portion of the elongated inner casing, the above ground panel having an above ground user interface. The system can include an above ground panel at an upper portion of the elongated inner casing, the above ground panel having an above ground solar panel, the solar panel adapted to charge the power source. The plurality of electrodes within the chamber can include elongated stalactite electrodes that extend into the chamber. The elongated stalactite electrodes can be retractable into the elongated inner casing, and wherein the elongated stalactites can be spring loaded and adapted to deploy quickly when a rodent enters the chamber. The chamber can include a platform at a bottom portion of the chamber, the platform defining a floor of the chamber, wherein the platform is spring loaded and adapted to pull the platform upwards and decrease the size of the chamber when a rodent enters the chamber. The chamber can include a platform at the bottom of the chamber, the platform defining a floor of the chamber, and wherein the platform has multiple electrodes disposed thereon, the multiple electrodes having a first polarity and a second polarity on the floor of the chamber. The outer casing can include a series of serrated teeth disposed around the bottom edge of the outer casing, the teeth adapted to help a user cut a cylindrical hole between the ground and the rodent tunnel.

A rodent trap can include an elongated cylindrical casing that is sized and shaped to extend downward within a cylindrical hole, the elongated inner casing defining a chamber at a bottom portion of the elongated inner casing, a plurality of electrodes within the chamber, a power source adapted to provide electric current to the electrodes to electrocute a rodent, and an above ground panel that remains above the surface while the elongated cylindrical casing is within the cylindrical hole, the above ground panel having a diameter that is larger than the diameter of the elongated cylindrical casing.

In various embodiments, the rodent trap can include a battery, wherein the above ground panel further comprises an above ground solar panel operatively connected to the battery and adapted to collect solar energy to charge the battery. The above ground panel can include an above ground user interface. The plurality of electrodes within the chamber can include elongated stalactite electrodes that extend into the chamber. The chamber can include a platform at a bottom portion of the chamber, the platform defining a floor of the chamber, wherein the platform is spring loaded and adapted to pull the platform upwards and decrease the size of the chamber when a rodent enters the chamber. The chamber can include a platform at the bottom of the chamber, the platform defining a floor of the chamber, and wherein the platform has multiple electrodes disposed thereon, at least one of the multiple electrodes on the floor of the chamber having a first polarity and at least one of the multiple electrodes on the floor of the chamber having a second polarity. The rodent trap can include an outer casing, the outer casing having a cylindrical outer body adapted to create a cylindrical hole between an underground rodent tunnel and a surface of the ground, wherein the inner diameter of the outer casing is larger than the outer diameter of the elongated inner casing by approximately 1 inch or less.

A method of exterminating rodents can include installing a rodent trap within the ground, the rodent trap having an elongated inner casing that is sized and shaped to fit within a cylindrical hole, the elongated inner casing defining a chamber at a bottom portion of the elongated inner chamber, the chamber having a plurality of electrodes within the chamber, and the rodent trap having a user interface, orienting the elongated inner casing by twisting the inner casing so that an opening of the chamber is aligned with a rodent tunnel so that a rodent in the tunnel can enter the chamber, and arming the rodent trap using a switch on the top portion of the rodent trap.

The rodent trap may have an above ground panel connected to and extending above the elongated inner casing, the above ground panel having a diameter that is larger than the diameter of the elongated inner casing, and wherein installing the rodent trap within the ground further comprises placing the elongated inner casing within the hole in the ground, so that the connected above ground panel rests on the ground with the elongated inner casing extending below the above ground panel. The method can include observing an indicator light on the above ground panel, the indicator light indicating that a rodent has been exterminated in the trap, grasping an above ground handle on the above ground panel, lifting the trap out of the hole, and cleaning the trap by removing the exterminated rodent. The method can include cutting a cylindrical hole by pushing and twisting a cylindrical outer body adapted to create a cylindrical hole between an underground rodent tunnel and a surface of the ground, the cylindrical outer body having one or more handles disposed around the upper portion of the outer casing, the handles adapted for a user to push and/or twist the cylindrical outer body into the ground, and the cylindrical outer body having a series of serrated teeth disposed around the bottom edge of the outer casing, the teeth adapted to help a user cut a cylindrical hole between the ground and the rodent tunnel.

### BRIEF DESCRIPTION OF THE DRAWINGS

The invention description below refers to the accompanying drawings, of which:

FIG. 1 is an overview diagram of an environment with a rodent trap that has been inserted into the ground in line with an underground rodent pathway, according to an illustrative embodiment;

FIG. 2 is a schematic diagram of an electrical environment for a rodent trap, according to an illustrative embodiment;

FIG. 3A is a detailed view of an extermination chamber of a rodent trap with various electrodes, according to an illustrative embodiment;

FIG. 3B is a detailed view of an extermination chamber of a rodent trap with a central pillar, according to an illustrative embodiment;

FIG. 3C is a detailed view of an extermination chamber of a rodent trap with multiple floor electrodes, according to an illustrative embodiment;

FIG. 3D is a schematic view of an extermination chamber of a rodent trap with a spring-loaded platform, according to an illustrative embodiment;

FIG. 4A is a perspective view of an outer casing, according to an illustrative embodiment;

FIG. 4B is a perspective view of the trap within the outer casing, according to an illustrative embodiment;

FIG. 5A is a side view of an outer casing showing dimensions, according to an illustrative embodiment;

FIG. 5B is a side view of a rodent trap showing dimensions, according to an illustrative embodiment; and

FIG. 6 is a flowchart illustrating a method for exterminating a rodent, according to an illustrative embodiment.

### DETAILED DESCRIPTION

The description herein includes a novel system and method of use for exterminating rodents through an electrically operated shock assembly. Although this invention is disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described herein.

In various instances, well-known structures and devices are shown in diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined. It cannot be emphasized too strongly, however, that these are descriptions of implementations of the invention, and not descriptions of the invention, which is not limited to the detailed implementations described in this section but is described in broader terms in the claims. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

One or more embodiments of the present disclosure relates to a rodent extermination device employing an electrically activated shock mechanism. The rodent trap can include an outer casing that may penetrate a ground surface and reach a rodent tunnel, and an inner casing that may be removably positioned within the outer casing. The inner casing may be equipped with a power source that includes a battery and/or a solar panel, and may include a switch to control the activation and deactivation of the trap. The electric shock mechanism may include conductive plates arranged to form an open passage configured for rodent entry. When a rodent contacts the conductive plates, an electric shock may be delivered to facilitate extermination. In an embodiment, one or more flexible electrodes may be positioned within the open passage to enhance the likelihood and/or sufficiency of contact. The outer casing may be further equipped with a serrated lower edge and one or more handles adapted to facilitate a rotating or twisting to support ground insertion and removal, while the inner casing may include a movable handle to assist with vertical insertion and withdrawal.

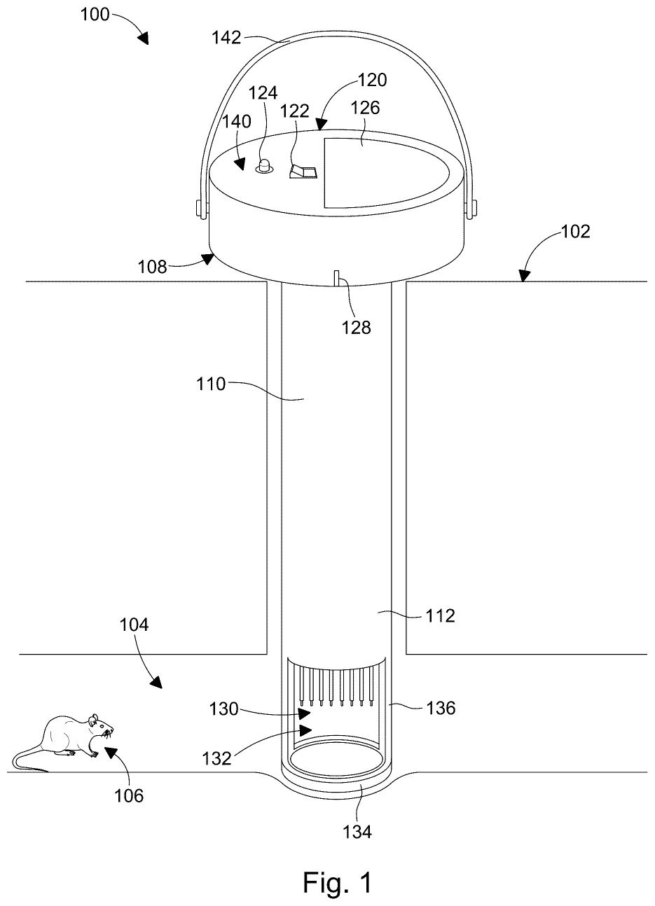

FIG. 1 is an overview diagram of an environment with a rodent trap that has been inserted into the ground in line with an underground rodent pathway, according to an illustrative embodiment. The exemplary environment 100 for the deployed rodent trap may include ground surface 102, rodent tunnel 104, a rodent 106, and the rodent trap 108. The ground surface 102 may include a layer of soil, earth, and/or any terrain capable of being penetrated to access subterranean rodent tunnels. Further, the ground surface 102 may include natural or cultivated land in a residential, commercial, or agricultural setting. For a person skilled in the art, while the term “ground surface” is used herein to describe the interface between the exposed land and the subterranean region, other terms such as “ground,” “soil,” or “terrain” may be used interchangeably in alternative embodiments, depending on contextual usage, environmental conditions, or customary terminology within a given application domain.

In an embodiment, the rodent pathway 104 may include any burrow, tunnel, or cavity formed underground by rodent activity. As used herein, the terms rodent pathway, burrow, tunnel, and/or cavity may be used interchangeably. The rodent tunnel system 104 may extend in multiple directions and may vary in diameter. In an embodiment, the rodent tunnel may be visible from the surface, or may be artificially detected, mapped, or reopened based on historical rodent behavior. The rodent 106 may be present within and/or near the rodent tunnel 104. In an embodiment, the rodent 106 may include a gopher, mole, vole, ground squirrel, prairie dog, rat, or any other burrowing rodent species targeted for extermination. The physical size and behavior of the rodent 106 may influence the positioning, activation timing, or plate arrangement of the extermination device.

As used herein, the terms rodent extermination device, device, rodent trap, and/or trap can be used interchangeably. In an embodiment, the rodent extermination device may provide for the humane and efficient elimination of burrowing rodents through the controlled application of electric shock. The device may include an outer casing (not shown in FIG. 1) to penetrate the ground surface 102 and access the subterranean rodent tunnel 104, and the inner casing 110 that can be removably positioned within the ground. In an embodiment, the outer casing may serve as a soil-penetrating guide structure to reach the rodent tunnel and facilitate the positioning of the inner casing.

The rodent trap 108 may be partially or fully positioned within or above the ground surface 102 and aligned with the rodent tunnel 104. The positioning may vary based on the depth of the tunnel, soil composition, or user preference. The rodent trap 108 that may house an electric shock assembly operable to deliver a lethal electrical charge upon detection or contact with the rodent 106. The rodent trap 108 may include an inner casing 110 that can be sized and shaped to fit within the outer casing, and sized and shaped to fit within a hole cut into the ground by the outer casing. The inner casing 110 may support, align, and protect the operative electrical components responsible for exterminating rodents 106. In an embodiment, the inner casing 108 may be vertically aligned to ensure that its internal passage, which houses the conductive and electrode elements, is oriented toward a rodent tunnel 104 beneath the ground surface 102. The trap 108 can include various handles 130 that may allow the user to grasp and lift the trap out of the ground and/or the outer casing.

The rodent trap 108 may include an above ground panel 120. The above ground panel 120 can remain above the ground and accessible, even as the trap 108 is deployed and the inner casing 110 is within the ground. The above ground panel 120 can include a user interface 140 that can include a switch 122 and/or indicator light 124. The switch 122 can be accessed by the user above ground to arm and disarm the rodent trap while the rodent trap is installed within the ground. The user interface 140 of the above ground panel 120 can include one or more indicator lights 124. Indicator light(s) 124 can communicate various information to the user while the inner casing remains in the ground. Indicator light(s) can inform the user about the armed or disarmed status of the trap. Indicator lights can inform the user about the energy stores within the trap, including energy stored within the battery, which may include energy collected by solar panels 126. Such information can include battery levels and/or binary information about whether or not the trap has sufficient energy stores to electrocute a rodent. Indicator light(s) 124 may signal to the user when a rodent has been electrocuted by the trap. Indicator light(s) may indicate to the user when the trap needs to be removed and cleaned, due to an electrocuted rodent and/or debris within the extermination chamber 130. An indicator light may inform a user that the user needs to lift the trap out of the ground and clear away various debris that may include a trapped rodent. The solar panel above the ground can charge the battery while the trap remains in the ground.

The trap can include an extermination chamber 130 can be placed along the rodent pathway while the inner casing 110 remains in the ground. In various embodiments, an extermination chamber 130 may be a passage or other opening that a rodent can enter and be electrocuted. In various embodiments, the extermination chamber 130 may be an extermination corridor 132 that may be a passageway that extends entirely through the inner casing, so that the rodent may enter the corridor 130 with the intention of passing through the corridor and out the other side. In various embodiments, an extermination chamber 130 may be an opening in the side of the inner casing 110 that may or may not extend entirely through the inner casing. In various embodiments, the extermination chamber may include a platform 134 that may be supported by, and connected to the trap body 112, by one or more pillars 136. The above ground panel 120 may have an alignment mark 128 that can indicate the direction of the extermination chamber 130. The alignment mark can help the user to ensure the trap is placed in the correct rotational alignment for a rodent traveling through the tunnel to enter the chamber 130.

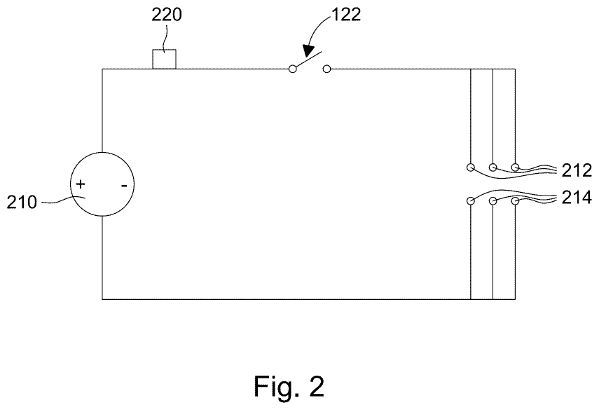

FIG. 2 is a schematic diagram of an electrical environment for a rodent trap, according to an illustrative embodiment. A rodent trap can have an electrical power source 210 that can be a battery, a household electrical connection, or other sources of electrical power. In various embodiments, the rodent trap can have a switch 122 that can arm and disarm the trap. The rodent trap can also include at least two electrodes 212 and 214. Electrodes 212 and 214 can represent positive and negative electrodes. Electrodes 212 can be positive and 214 can be negative, or 212 can be negative and 214 can be positive. The exact polarity may not be significant, and electrode 212 can be a first polarity and electrode 214 can be a second polarity. When a rodent makes contact with the electrodes 212 and 214, the rodent can complete a circuit, so that electrical power flows through the circuit, including through the rodent, thereby electrocuting the rodent when the rodent completes the circuit. It should be clear that there may be one or more of electrode 212, and there may be one or more of electrode 214. In order to complete the circuit and thereby electrocute itself, the rodent must make contact with at least one positive electrode and at least one negative electrode at the same time.

In various embodiments, a sensor 220 can detect the flow of electricity through the circuit. The sensor 220 can provide a signal to an indicator light, wireless communication device, or other system for indicating that the trap may have been triggered. In various embodiments, a sensor 220 can provide a signal to a spring floor or various other systems or components indicating that the trap was likely triggered because a circuit was completed.

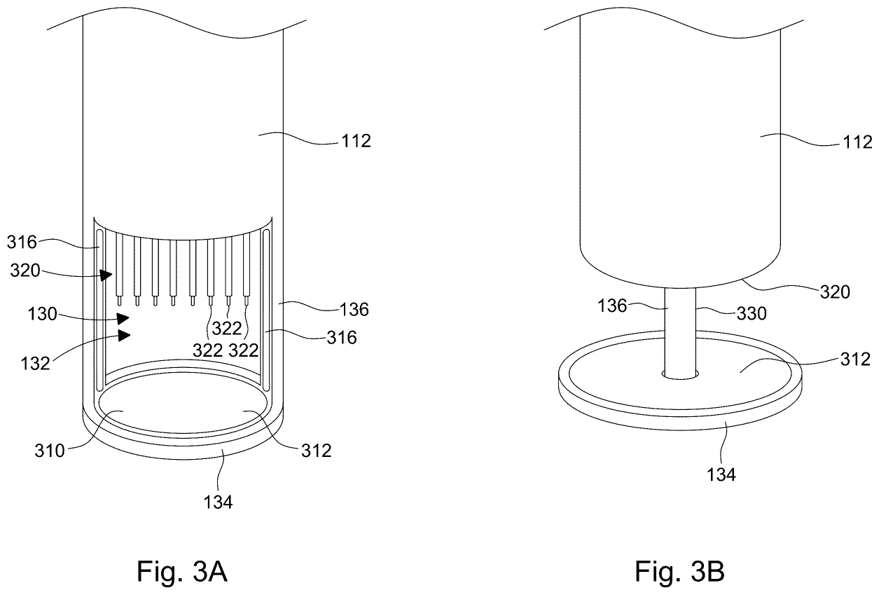

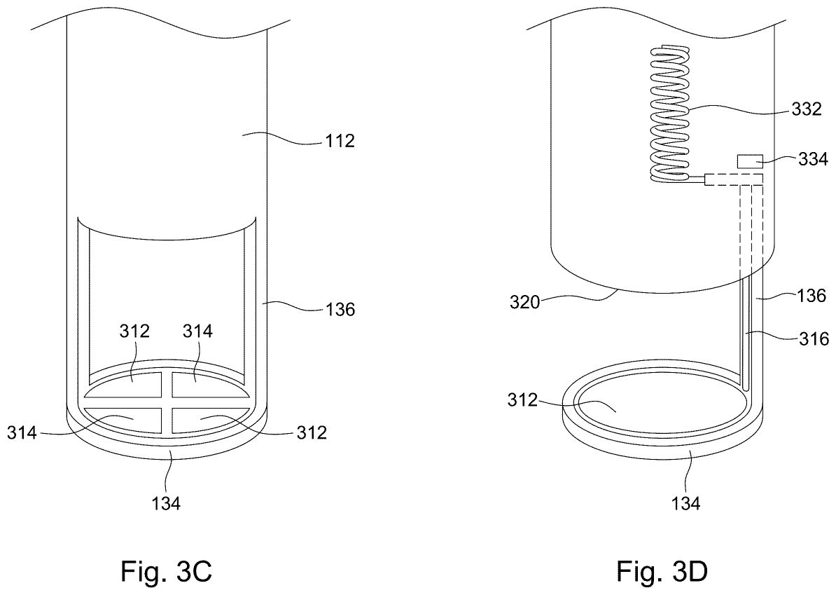

FIG. 3A is a detailed view of an extermination chamber of a rodent trap with various electrodes, according to an illustrative embodiment. An extermination chamber 130 can have one or more electrode panels 310. Electrode panels 310 can include a floor electrode 312 and/or one or more sidewall electrodes 316. In various embodiments, an extermination chamber can include one or more overhead electrode(s) 320. Overhead electrode(s) 320 can be electrode panel(s), and/or can be one or more stalactite electrodes 322. Stalactite electrodes 322 can extend down from an upper area of the extermination chamber 130 and can extend down into the extermination chamber 130. Stalactite electrodes may be positioned to dangle or project into the space traversed by the rodent, thereby increasing the probability of physical contact and completing the circuit even if the rodent does not fully contact other electrodes. Stalactite electrodes can flexible protrusions and/or rigid protrusions. Stalactite electrode can be made of wires, metals, or other materials, and can be electrically conductive with electrodes at the ends, or can be electrically conductive along the length of the stalactite. In various embodiments, elongated electrodes can extend onto the chamber from sidewalls and or the floor of the chamber, however, in the interest of clarity, any elongated electrodes extending into the chamber can be referred to as stalactite electrodes, regardless of orientation and direction.

In various embodiments, the stalactite electrodes 322 may be mounted on a retractable assembly that allows them to withdraw or collapse into a recessed position when not in use. Such retractability may be achieved using spring-loaded mounts, hinged arms, or sliding brackets that bias the stalactite electrodes 322 inward or upward during storage or transport. In an embodiment, the electrodes may deploy automatically when the inner casing is inserted into the ground surface or when the power switch is engaged. The combination of flexibility and retractability may reduce wear, prevent unintended activation, and facilitate cleaning and maintenance, while also protecting the electrodes during handling or non-operational conditions.

It should be clear to one of skill in the art that one or more various electrodes can be positive and one or more various electrodes can be negative. A rodent can be electrocuted upon contacting at least one positive and at least one negative electrode. The arrangement of the conductive surfaces may vary across embodiments, with some configurations including opposing plates on vertical and horizontal planes to optimize current flow and shock efficiency. By way of non-limiting example, the floor panel 312 may be a first polarity, and the sidewall panels 316 may be a second polarity. In various embodiments, the floor panel may be a first polarity, and the overhead electrodes may be a second polarity. In various embodiments, one sidewall panel may be a first polarity and a second sidewall panel may be a second polarity. In various embodiments, different stalactite electrodes may be different polarities, so that the rodent can be electrocuted by completing a circuit between at least one positive polarity stalactite electrode and at least one negative polarity stalactite electrode.

FIG. 3B is a detailed view of an extermination chamber of a rodent trap with a central pillar, according to an illustrative embodiment. An extermination chamber may have various arrangements of electrodes. An extermination chamber may have one or more floor electrode(s) 212, one or more pillar electrode(s) 330 and/or one or more overhead electrodes 220. By way of non-limiting example, the floor electrode(s) 312 can carry a first polarity, and the pillar electrode(s) 330 and/or overhead electrodes 320 can carry a second polarity.

FIG. 3C is a detailed view of an extermination chamber of a rodent trap with multiple floor electrodes, according to an illustrative embodiment. A rodent trap can have a plurality of floor electrode 312 and 314. In various embodiments, different floor electrodes can have different polarities. In embodiments with different polarities on different floor electrodes 312 and 314, a rodent can be electrocuted or partially electrocuted by stepping on two different floor electrodes to complete the circuit.

FIG. 3D is a schematic view of an extermination chamber of a rodent trap with a spring-loaded platform, according to an illustrative embodiment. In various embodiments, the rodent trap can have a spring-loaded platform 314. The trap can have a spring 332 inside of the inner casing 110 that can store potential energy, and the release of the stored potential energy can pull the platform 314 towards the trap body 112. A release mechanism 334 can be triggered to release the stored potential energy. Various means may be possible to trigger the release mechanism so that the stored energy can pull the platform towards the trap body. In various embodiments, the completion of a circuit can be detected by a sensor, and the sensor can provide a signal to an electromechanical release mechanism that can then move out of the way and allow the spring to pull the platform towards the trap body. In various embodiments, the release mechanism can be a physical trigger, with similar operation to that of a standard mousetrap or other triggering mechanism that can be triggered by small amounts of physical force to move aside to allow the release of stored potential energy to pull the platform upwards.

As the platform is pulled upwards towards the trap body, the rodent can be trapped between positive and negative electrodes, thereby not only completing the circuit, but preventing the rodent from jumping away and escaping when the current starts flowing. By way of non-limiting example, a rodent that steps on two distinct floor electrodes with first and second polarities may trigger the spring-loaded floor platform, thereby pressing the rodent against additional electrode(s) that may be overhead electrodes, sidewall electrodes, and/or pillar electrodes. As the rodent is pinned against the multiple electrodes, the rodent can be securely electrocuted without the opportunity to escape.

In various embodiments, the stored potential energy may be used to drive overhead electrodes downward instead of pulling the platform upward. In various embodiments, the stored potential energy may be used to drive stalactite electrodes downward into the rodent. By driving the overhead electrodes, such as stalactite electrodes, downward into the rodent the rodent can be pinned by the electrodes and securely electrocuted without the opportunity to escape.

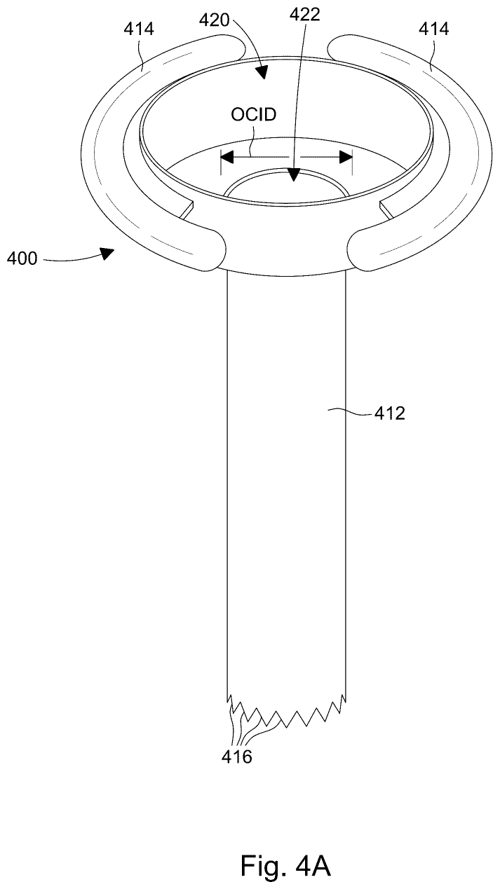

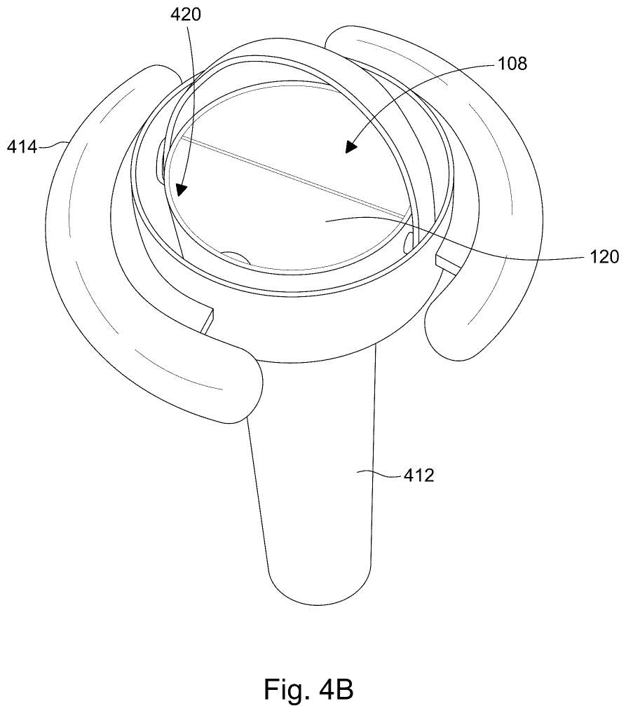

FIG. 4A is a perspective view of an outer casing, according to an illustrative embodiment. An outer casing 400 can have a cylindrical outer body 412 that can be sized and shaped to accommodate the trap body 112 of the rodent trap 108. The outer casing can be designed to be pushed into the ground to form a hole between the rodent pathway and the surface above the ground. The bottom edge of the outer body 412 can include a sharpened edge and/or serrations 416. The outer casing 400 can include one or more handles 414 that can be adapted to facilitate a user pushing and twisting the outer casing to drive the cylindrical outer body into the ground. The user can drive the outer casing into the ground to form the hole between the rodent tunnel and the surface of the ground. In various embodiments, the user can then pull the outer casing casing out of the ground, along with the dirt held within the cylindrical outer body, thereby leaving the passage way between the rodent tunnel and the surface.

In various embodiments, the outer casing 400 can have a pan 420 that can be adapted to hold the above ground panel of the trap. The inner casing and body of the trap can fit within the cylindrical outer body 412, and the above ground panel can nest within the pan 420. The central channel 422 of the outer body 412 can have an inner diameter that can be larger than the outer diameter of the trap body, so that the trap body can fit within the cylindrical outer body 412. The diameter of the outer body can be larger than the diameter of the trap body, so that the trap body can fit within a hole in the ground formed by the outer body 412.

FIG. 4B is a perspective view of the trap within the outer casing, according to an illustrative embodiment. The trap 108 can be removably housed within the outer casing 400. The inner casing can be within the cylindrical outer body 412, and the above ground panel 120 can lie within the pan 420. The trap 108 can be stored within the outer casing, so that they can be stored together and require minimal space. Furthermore, in this storage mode with the trap stored within the outer casing, the outer casing may protect the trap, including protecting the chamber and any delicate or sensitive equipment or electrodes within the chamber.

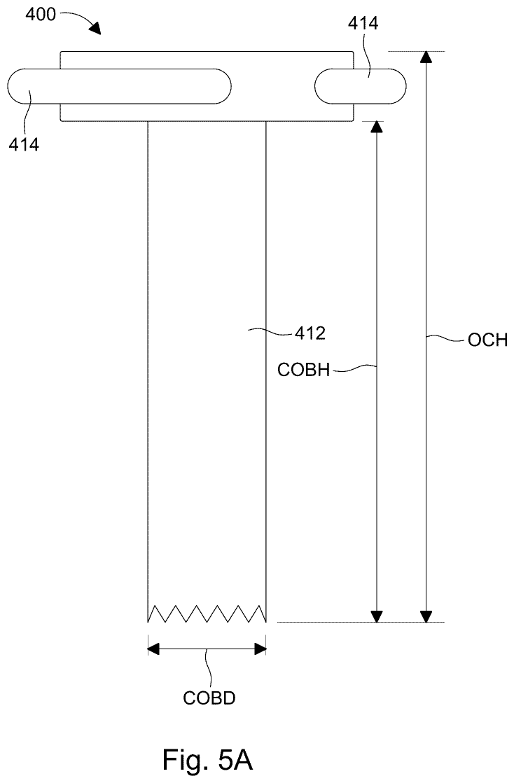

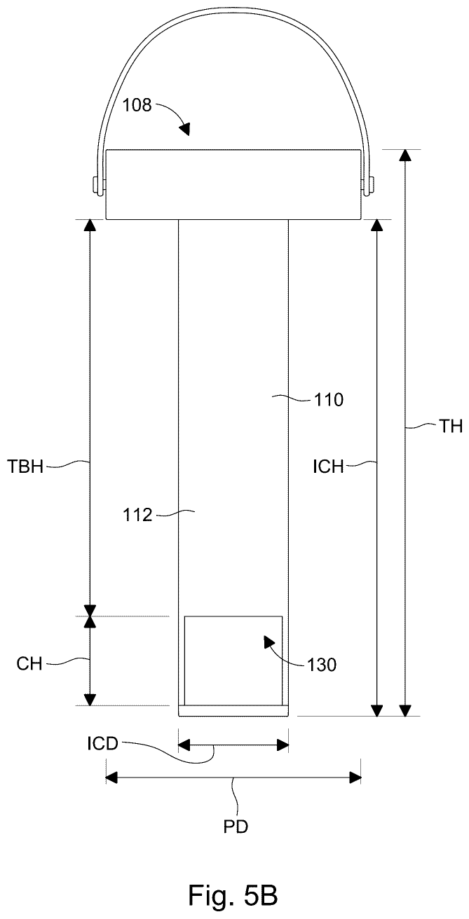

FIG. 5A is a side view of an outer casing showing dimensions, according to an illustrative embodiment, and FIG. 5B is a side view of a rodent trap showing dimensions, according to an illustrative embodiment. Various dimensions of a rodent trap and outer casing are described herein, however, it should be clear that different sizes are possible, and can be intended to exterminate different rodents of different sizes. However, in various embodiments, a similar relationship may exist between dimensions of the trap 108 and dimensions of the outer casing 400.

In various embodiments, an outer casing can have a total outer casing height OCH of approximately 16 inches, and a cylindrical outer body height COBH of approximately 14 inches. The outer casing can have a cylindrical outer body with a cylindrical outer body diameter COBD of approximately 3.5 inches. The bottom of the tube can have serrated teeth to facilitate the tube being driven into the ground. The outer casing can have one or more handles 414 to assist with insertion, removal, and alignment with a tunnel opening. The user can push and/or twist on the handles 414 to push the cylindrical outer tube into the ground, and the user can pull the cylindrical outer body out of the ground with the dirt and/or grass inside, so that the user can replace the material back into the hole later. The ability to lift and replace the soil plug may be particularly advantageous for landscaping or turf-sensitive applications.

In various embodiments, a trap 108 can have a trap height TH of approximately 15.8 inches. In various embodiments, a trap 108 can have a trap height TH that can be slightly shorter than the total outer casing height OCH of the outer casing, such as, for example, 0.2 inches shorter than the total outer casing height OCH of the outer casing. A trap 108 can have an inner casing height ICH of approximately 13.9 inches, In various embodiments, a trap can have an inner casing height ICH that can be slightly shorter than the cylindrical outer body height COBH, such as, for example, 0.1 inches shorter than the cylindrical outer body height COBH. In various embodiments, a trap 108 can have a inner casing diameter ICD that can be approximately 2.8 inches. In various embodiments, the inner casing diameter ICD can be slightly smaller than the outer casing inner diameter OCID so that the inner casing fits within the outer casing. In various embodiments, the dimensions of the inner casing 108 may be selected to ensure a close but removable fit within the outer casing 202, while allowing sufficient clearance to accommodate thermal expansion, debris, or alignment tolerances. In various embodiments, the outer casing inner diameter OCID can be approximately 3 inches. In various embodiments, the outer casing inner diameter OCID can be larger than the inner casing diameter by less than approximately 1 inch. In various embodiments, the outer casing inner diameter OCID can be larger than the inner casing diameter by less than approximately 0.5 inches.

In various embodiments, the trap 108 can have an above ground panel diameter PD of approximately 4.8 inches. In various embodiments, the above ground panel can have a panel diameter PD that is greater than the inner casing diameter ICD or the outer casing inner diameter OCID. The greater diameter of the above ground panel ensures that the panel rests on the surface of the ground while the inner casing is within the hole created by the outer casing. This can help to ensure that the top of the trap remains above ground. The top of the trap will remain above ground by resting on top of the ground surface, despite the trap body being pulled downward by gravity and despite soft muddy ground or rain.

In various embodiments, the trap 108 can have a trap body height TBH of approximately 10.1 inches. In various embodiments, the trap 108 can have a chamber height CH that can be approximately 3.5 inches. It should be clear that the dimensions provided herein are intended to be exemplary and non-limiting, and various sizes are possible. Trap body height TBH may be approximately the same or less than the depth of a rodent tunnel below the surface. The chamber height CH may be selected to match the width of the tunnel and/or width of the rodent the trap is designed for. The chamber can align with the rodent tunnel, so that a rodent traveling through the rodent tunnel can automatically enter the chamber when the trap is placed along the tunnel pathway. In various embodiments, the trap may include adjustable or interchangeable sections, which may allow for customization in length or functionality. In particular, this adjustability and flexibility in the length of the device can allow the chamber to be positioned at the ideal depth to align with various rodent tunnels, although various rodent tunnels may be at different depths.

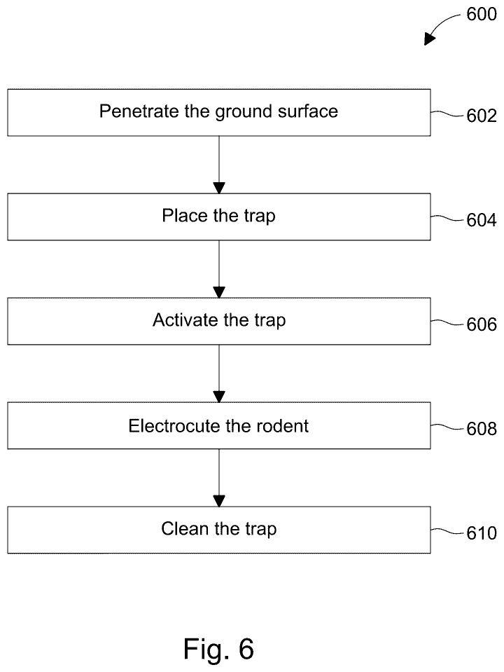

FIG. 6 is a flowchart 600 illustrating a method for exterminating a rodent, according to an illustrative embodiment. At box 602, the user can penetrate the ground surface. The user can use outer casing of a rodent extermination system to access a rodent tunnel. The rodent may include a gopher, a mole, a vole, a ground squirrel, a prairie dog, and/or a rat. In various embodiments, the outer casing may include a serrated lower edge to assist in penetrating the ground surface. Further, the outer casing may include handles to facilitate insertion and removal from the ground surface. The user may remove a core of the ground within the outer casing, thereby creating an opening between the ground surface and the rodent tunnel.

At box 604, the user can place the inner casing of the trap within the hole created in 602. The user can twist the trap so that the chamber is aligned with the direction of travel of the rodent pathway. An alignment mark may assist the user in aligning the chamber with the rodent pathway.

At box 606, the user can active the trap. The trap can be activated by switching switch that is located above the ground surface while chamber is located below the surface at the rodent tunnel. At box 608, a rodent can be electrocuted by the trap. In various embodiments, an indicator light can be illuminated above ground when the rodent has been exterminated below ground. At box 610, the user can see the indicator above ground, and can lift the trap out of the ground and dispose of the exterminated rodent in the chamber. The user does not need to lift the trap out of the hole to check the trap, because the indicator light above ground can tell the user when a rodent has been caught by the trap.

One or more embodiments of the present disclosure relate to a device and method for rodent extermination, designed for humane, efficient, and environmentally conscious elimination of burrowing rodents. The disclosed device introduces a significant advancement in pest control by providing a hands-free extermination system that catches and exterminates rodents underground while a portion of the trap system remains above ground to collect and store solar energy, display indicator lights, and allow the user to arm and disarm the device from the above ground panel. Unlike traditional rodent control approaches, such as mechanical traps and chemical rodenticides, which often suffer from inefficiency, safety risks, and ecological harm, the disclosed device provides a robust and reusable solution that emphasizes reliability, ease of use, and minimal environmental impact. In various embodiments, the device may be scaled or adjusted to accommodate a wide range of rodent species, including gophers, moles, voles, ground squirrels, prairie dogs, and rats.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Accordingly, this description is meant to be taken only by way of example, and not to otherwise limit the scope of this invention.

What is claimed is:

1. A rodent extermination system comprising:
an outer casing comprising:
a cylindrical outer body adapted to create a cylindrical hole between an underground rodent tunnel and a surface of the ground; and
one or more more handles disposed around the upper portion of the outer casing, the handles adapted for a user to push and/or twist the cylindrical outer body into the ground; and
a rodent trap comprising:
an elongated inner casing that is sized and shaped to fit within the hole created by the cylindrical outer body, the elongated inner casing defining a chamber at a bottom portion of the elongated inner casing;
a plurality of electrodes within the chamber; and
a power source adapted to provide electric current to the electrodes to electrocute a rodent.

2. The rodent extermination system of claim 1, wherein the rodent trap further comprises an above ground panel at an upper portion of the elongated inner casing, the above ground panel having an above ground user interface.

3. The rodent extermination system of claim 1, wherein the rodent trap further comprises an above ground panel at an upper portion of the elongated inner casing, the above ground panel having a larger diameter than the diameter of the elongated inner casing, the above ground panel having an above ground solar panel, the solar panel adapted to charge the power source.

4. The rodent extermination system of claim 1, wherein the plurality of electrodes within the chamber includes elongated stalactite electrodes that extend into the chamber.

5. The rodent extermination system of claim 4, wherein the elongated stalactite electrodes can be retractable into the elongated inner casing, and wherein the elongated stalactites can be spring loaded and adapted to deploy quickly when a rodent enters the chamber.

6. The rodent extermination system of claim 1, wherein the chamber further comprises a platform at a bottom portion of the chamber, the platform defining a floor of the chamber, wherein the platform is spring loaded and adapted to pull the platform upwards and decrease the size of the chamber when a rodent enters the chamber.

7. The rodent extermination system of claim 1, wherein the chamber further comprises a platform at the bottom of the chamber, the platform defining a floor of the chamber, and wherein the platform has multiple electrodes disposed thereon, at least one of the multiple electrodes on the floor of the chamber having a first polarity and at least one of the multiple electrodes on the floor of the chamber having a second polarity.

8. The rodent extermination system of claim 1, wherein the outer casing further comprises a series of serrated teeth disposed around the bottom edge of the outer casing, the teeth adapted to help a user cut a cylindrical hole between the ground and the rodent tunnel.

9. A rodent trap comprising:
an elongated cylindrical casing that is sized and shaped to extend downward within a cylindrical hole, the elongated inner casing defining a chamber at a bottom portion of the elongated inner casing;
a plurality of electrodes within the chamber;
a power source adapted to provide electric current to the electrodes to electrocute a rodent; and
an above ground panel that remains above the surface while the elongated cylindrical casing is within the cylindrical hole, the above ground panel having a diameter that is larger than the diameter of the elongated cylindrical casing.

10. The rodent trap of claim 9, further comprising a battery, wherein the above ground panel further comprises an above ground solar panel operatively connected to the battery and adapted to collect solar energy to charge the battery.

11. The rodent trap of claim 9, wherein the above ground panel further comprises an above ground user interface.

12. The rodent trap of claim 9, wherein the plurality of electrodes within the chamber includes elongated stalactite electrodes that extend into the chamber.

13. The rodent trap of claim 12, wherein the elongated stalactite electrodes can be retractable into the elongated inner casing, and wherein the elongated stalactites can be spring loaded and adapted to deploy quickly when a rodent enters the chamber.

14. The rodent trap of claim 9, wherein the chamber further comprises a platform at a bottom portion of the chamber, the platform defining a floor of the chamber, wherein the platform is spring loaded and adapted to pull the platform upwards and decrease the size of the chamber when a rodent enters the chamber.

15. The rodent trap of claim 9, wherein the chamber further comprises a platform at the bottom of the chamber, the platform defining a floor of the chamber, and wherein the platform has multiple electrodes disposed thereon, at least one of the multiple electrodes on the floor of the chamber having a first polarity and at least one of the multiple electrodes on the floor of the chamber having a second polarity.

16. The rodent trap of claim 9, further comprising an outer casing, the outer casing comprising a cylindrical outer body adapted to create a cylindrical hole between an underground rodent tunnel and a surface of the ground, wherein the inner diameter of the outer casing is larger than the outer diameter of the elongated inner casing by approximately 1 inch or less.

17. A method of exterminating rodents, the method comprising:
installing a rodent trap within the ground, the rodent trap having an elongated inner casing that is sized and shaped to fit within a cylindrical hole, the elongated inner casing defining a chamber at a bottom portion of the elongated inner chamber, the chamber having a plurality of electrodes within the chamber, and the rodent trap having a user interface;
orienting the elongated inner casing by twisting the inner casing so that an opening of the chamber is aligned with a rodent tunnel so that a rodent in the tunnel can enter the chamber;
arming the rodent trap using a switch on the top portion of the rodent trap.

18. The method of claim 17, wherein the rodent trap has an above ground panel connected to and extending above the elongated inner casing, the above ground panel having a diameter that is larger than the diameter of the elongated inner casing, and wherein installing the rodent trap within the ground further comprises placing the elongated inner casing within the hole in the ground, so that the connected above ground panel rests on the ground with the elongated inner casing extending below the above ground panel.

19. The method of claim 18, further comprising:
observing an indicator light on the above ground panel, the indicator light indicating that a rodent has been exterminated in the trap;
grasping an above ground handle on the above ground panel;
lifting the trap out of the hole; and
cleaning the trap by removing the exterminated rodent.

20. The method of claim 17 further comprising cutting a cylindrical hole by pushing and twisting a cylindrical outer body adapted to create a cylindrical hole between an underground rodent tunnel and a surface of the ground, the cylindrical outer body having one or more handles disposed around the upper portion of the outer casing, the handles adapted for a user to push and/or twist the cylindrical outer body into the ground, and the cylindrical outer body having a series of serrated teeth disposed around the bottom edge of the outer casing, the teeth adapted to help a user cut a cylindrical hole between the ground and the rodent tunnel.
